(19) United States
(12) Patent Application Publication
(10) Pub. No.: US 2014/0075099 A1
(43) Pub. Date: Mar. 13, 2014

(54) CONTROL METHOD AND MEMORY SYSTEM OF NON-VOLATILE SEMICONDUCTOR MEMORY

(71) Applicant: KABUSHIKI KAISHA TOSHIBA, Tokyo (JP)

(72) Inventor: Taku OONEDA, Tokyo (JP)

(73) Assignee: KABUSHIKI KAISHA TOSHIBA, Tokyo (JP)

(21) Appl. No.: 13/786,025

(22) Filed: Mar. 5, 2013

(30) Foreign Application Priority Data
Sep. 10, 2012 (JP) P2012-198816

(51) Int. Cl. G06F 12/02; G06F 11/10

(52) U.S. Cl. CPC G06F 12/0246; G06F 11/1008
USPC 711/103; 714/773

(57) ABSTRACT

A method and a device for controlling a non-volatile semiconductor memory device having a plurality of physical memory blocks are described. The control method includes forming a logical block including normal physical blocks and a defective physical block. Then read-only data (which can include system data and user data which is infrequently used) is targeted for a write to the defective physical block. Instead of actually writing the read-only data in the defective physical block, an error correction coding generated using the read-only data is stored in the normal physical blocks together with other data. When the read-only data is requested to be read, the read-only data is reproduced using the error correction coding.

### CROSS-REFERENCE TO RELATED APPLICATION

This application is based upon and claims the benefit of priority from Japanese Patent Application No. 2012-198816, filed Sep. 10, 2012; the entire contents of which are incorporated herein by reference.

### FIELD

Embodiments described herein relate to a control method of non-volatile semiconductor memory and memory system.

### BACKGROUND

Flash memory, which is a type of non-volatile semiconductor memory, has the following features: Data stored in the memory blocks cannot be overwritten directly; rather the memory block must be erased before it can be written to again. But repeated cycles of erasing and rewriting a memory block can cause the memory block to become defective (that is, cause data read/write errors). And if data is read repeatedly from a memory block without a rewrite (i.e., a refresh), the data in the memory block can accumulate errors (that is, there will be an increase in read-time errors). At some point in time the number of errors accumulated in a memory block crosses a threshold, and although the number of errors can be controlled by performing the refresh process by rewriting to a different memory block, it generally desirable that the frequency of rewrite for the flash memory be decreased so as to improve device lifetime and maintain performance levels over time.

### DESCRIPTION OF THE DRAWINGS

FIG. 1 is a block diagram depicting an example solid state drive (SSD) according to an embodiment.

FIG. 2 is a diagram illustrating a coding process of an error correction coding (ECC) processor.

FIG. 3 is a diagram for illustrating the decoding process of the ECC processor.

FIG. 4 is a block diagram showing an example configuration in which two storage areas are defined in the NAND flash memory.

FIG. 5 is a diagram showing an example of a full logic block and a defective logic block.

FIG. 6 is a diagram depicting a method of storing data to a defective logical block.

FIG. 7 is a diagram illustrating a method of storing data to multiple defective logical blocks.

FIG. 8 is a diagram depicting an address conversion table.

FIG. 9 is a diagram depicting a logical block management table.

FIG. 10 is a diagram depicting a bad block table.

FIG. 11 is a block diagram schematically illustrating a NAND flash memory organization.

FIG. 12 is a flowchart illustrating a procedure related to writing read-only data (system data) to a defective logical block.

FIG. 13 is a flowchart illustrating a procedure of writing read-only data (user data) to a defective logical block.

FIG. 14 is a diagram schematically illustrating reallocation of data in a defective logical block.

FIG. 15 is a diagram schematically illustrating multiplexing of read-only data in logical blocks.

### DETAILED DESCRIPTION

The present disclosure describes a control method of a non-volatile semiconductor memory device and a memory system which improves lifetime for the non-volatile semiconductor memory by reducing the refresh frequency. In general, a detailed description of embodiments follows with reference to the attached figures.

According to one embodiment, a control method of non-volatile semiconductor memory which has physical blocks as the unit of data erasure, a logical block is formed to include multiple physical blocks and at least one physical block that is a defective block (a “bad” block). “Defective” in this context means a block with a read/write error level exceeding normally acceptable levels or a dummy physical block. Read-only data is written to the defective block. Other data besides the read-only data including, for example, error correction is written to the other (non-defective) physical blocks of the logical block. “Read-only” data in this context means system data which is not typically rewritten and/or a subset of user data which is infrequently rewritten. When reading the data from the logical block, the read-only data can be restored by using the coding result and the other data.

### First Embodiment

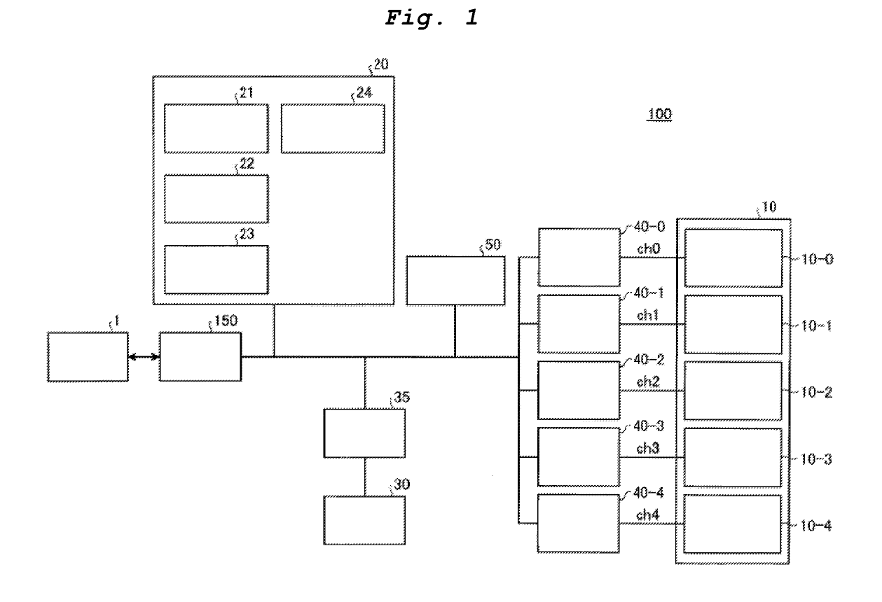

FIG. 1 is a block diagram showing a configuration of a memory system according to a first embodiment. Solid state drive (SSD) 100 is as an example of a storage system, but the embodiment is not restricted to only solid state drives. For example, this embodiment is applicable to external storage units such as semiconductor memory which stores non-volatile data and memory cards equipped with controllers.

SSD 100 is connected to host device 1 such as a personal computer through host interface (host I/F) 150 and functions as an external storage device of host device 1. SSD 100 provides a host I/F 150, a NAND-type flash memory (referred to as NAND flash) 10 (comprising, for example, NAND flash elements 10-0 to 10-4) in the non-volatile semiconductor which stores the data read and written by host device 1, a controller 20 which executes various controls related to data transfer control of SSD 100 and host device 1, RAM 30 including volatile memory such as DRAM (dynamic random-access memory) which controller 20 uses as storage for data transfer (i.e., a transfer cache), RAM controller (RAMC) 35 which controls the read and write of RAM 30, NAND controller (NANDC) 40 (comprising, for example, controller elements 40-0 to 40-4) which carries out data transfer control between NAND flash elements 10-0 to 10-4 and RAM 30 with the coordination of RAMC 35, and ECC (error correction coding) processor 50 which executes the ECC process (error correction coding/decoding) of data stored in a scattered manner extending over multiple NAND flash elements 10-0 to 10-4.

Under the control of controller 20, data transmitted from the host device 1 is temporarily stored in the RAM 30 through RAMC 35 and host I/F 150. After that, it is read from RAM 30 through RAMC 35 and NANDC 40 and written to NAND flash 10. The data read from NAND flash 10 is temporarily stored in RAM 30 by passing through NANDC 40 and RAMC 35, after which it is read from RAM 30 and transferred to host device 1 through RAMC 35 and host I/F 150.

NAND flash 10 stores the user data specified by host 1 and management information for backup purposes. NAND flash 10 has a memory cell array in which multiple memory cells are arranged in a matrix shape such that every memory cell uses an upper and lower page and multi-valued storage is accomplished. NAND flash elements 10-0 to 10-4 include multiple memory chips. Each memory chip includes a multi-array of physical blocks which is a unit of data erasure. Also, in the NAND flash 10, reading and writing of data is carried out in units of a physical page. A physical block includes multiple physical pages.

In this embodiment, NAND flash 10 is connected with NANDC 40 through five channels by which parallel operation is possible. That is, one channel (ch0 to ch4) is respectively allocated for NAND flash elements 10-0 to 10-4. In addition, one of the channels (e.g., ch4) is allocated as a channel for writing redundant information created by ECC processor 50. The remaining channels (e.g., ch0 to ch3) are allocated as channels for writing data from host device 1. The pages of data written through channels ch0 to ch4 are made into one group and the error correcting code is established for that group. That is, NAND flash elements 10-0 to 10-3 are used for data storage and, NAND flash element 10-4 is used for error correction coding. The group of five physical blocks corresponding to the five channels ch0 to ch4, including the error correction coding is called a logical block. NAND flash elements 10-0 to 10-4 are connected to NANDC 40-0 to 40-4 through respective channels ch0 to ch4, and NAND flash elements 10-0 to 10-4 can operate independently in parallel.

Host I/F 150 uses, for example, the ATA (Advanced Technology Attachment) communication interface standard and communication between SSD 100 and host device 1 is controlled according to the control of controller 20. Host I/F 150 receives the command transmitted by the host device 1. When writing is required for data for which a logical address (i.e., LBA: Logical Block Addressing) is specified by the command, the write command is sent to controller 20. Moreover, host I/F 150 sends data with the write request to RAM 30.

RAM 30 is used as a temporary storage unit for the data transfer. That is, it used to temporarily store the write request data before it is written to NAND flash 10 and to temporarily store the data resulting from a read request from host device 1 which is read from the NAND flash 10. Also, RAM 30 has a working area for storing and updating management information such as address conversion table 31, logical block management table 32, bad block table 33, and an area for temporarily storing the data read from NAND flash 10. Management information such as address conversion table 31, logical block management table 32, bad block table 33 are developed at the time of startup of the non-volatile management table, which may be stored in the NAND flash 10.

NANDC 40-0 to 40-4 execute control of the data transfer between NAND flash 10-0 to 10-4 and RAM 30. It provides a DMA (direct memory access) controller and NAND interface (I/F). The DMA controller controls data transfer between RAM 30 and NAND I/F according to a DMA method.

ECC processor 50 carries out the error correction coding process related to the write data temporarily stored in RAM 30. Write data is output to NANDC 40-0 to 40-3, and the error correction code is output to NANDC 40-4. NANDC 40-0 to 40-4 writes the input data and error correction code to NAND flash elements 10-0 to 10-4. Also, ECC processor 50 outputs data read from NAND flash elements 10-0 to 10-4 through NANDC 40-0 to 40-4 to RAM 30 by executing the error correction decoding process using the error correction code.

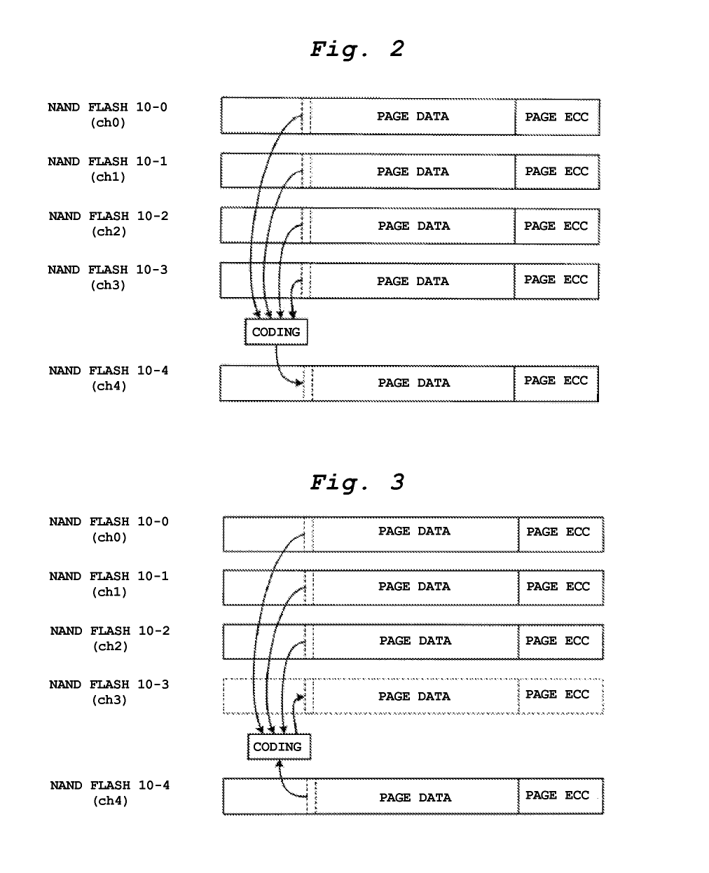

An example of the error correction coding process is shown in FIG. 2. In the error correction coding process, the error correction code is created using data stored in a scattered manner in independently writable NAND flash elements 10-0 to 10-3. In other words, the data is stored in multiple memory chips.

In FIG. 2, ECC processor 50 calculates the error correction code by using the four data stored in a same offset position from the head of the page in each channel ch0-ch3. For example, each of the four data can be byte-size data. The calculated error correction code is transferred as redundancy information from ECC processor 50 to NANDC 40-4 of channel ch4 and is written at the same position as an above-mentioned offset position in NAND flash element 10-4 by NANDC 40-4 of channel ch4.

In the error correction coding, one physical block from each channel ch0-ch3 is selected and one page is selected from each selected physical block. The offset of each selected page can also be set from the same byte (identical column) of identical location so that error correction code can be calculated. Alternatively, multiple physical blocks are selected from each channel ch0-ch3 and one page is selected from each selected physical block. The offset of each selected page can also be set from the same byte (identical column) of identical location so that error correction code can be calculated.

An example of the error correction decoding process is shown in FIG. 3. FIG. 3 depicts an example of restoring (correcting) abnormal data generated as a result of failures in NAND flash element 10-3 of channel ch3. The restoration shown in FIG. 3 indicates the case where parity is adopted as a coding method. More specifically, the data generated with an uncorrectable error and the data associated with the identical error correction code exist. The data written in NAND flash of the channel other than the channel corresponding to the data generated with the uncorrectable error and redundant information (here, each data written in channel ch0, ch1, ch2 and redundant information written in channel ch4) is read. Further, ECC processor 50 restores the data in channel ch3 by using byte data of the same offset that exists in the corresponding data and the redundant information. Furthermore, if the coding method is such that the data generated with an uncorrectable error can be restored by using the data written in NAND flash of a channel other than the channel corresponding to the data generated with an uncorrectable error and the redundant information, then other coding methods can also be adopted.

In addition to this, the error correction process performed by ECC processor 50 is not restricted to the data transmitted over the channels but the error correction code can also be formed for the data stored in the chip or the data stored in the physical block. More specifically, the error correction code can be generated from the data in multiple blocks and such error correction code can be written in different blocks.

In FIG. 1, controller 20 may operate using a system program (firmware) stored in NAND flash 10 and a processor running the firmware. Controller 20 includes a logical block building module 21, refresh control module 22, data access control module 23, and block management module 24. The logical block building module 21 and refresh control module 22 perform the logical block building process and refresh process, respectively.

The data access control module 23 performs a process of writing to NAND flash 10 through RAM 30, a process of reading from NAND flash 10, and data reduction (compaction) of NAND flash 10. A compaction process refers to taking a collection of valid data inside a logical block and rewriting it in a different logical block. In this manner, a new free block (a logical block to which data is not assigned) can be created.

The block management module 24 tracks (manages) the usage state of the block (that is, whether the block is an active block being used to store valid data or is a free block not being used). In addition to this, the block management module 24 also identifies and manages bad blocks which cannot be used as storage areas due to excessive errors. The block management module 24 identifies free blocks and active blocks usable by data access control module 23.

In SSD 100, a virtual block called a logical block is defined as a unit which collectively manages multiple physical blocks. In a preferred embodiment, logical blocks combine physical blocks such that parallel channel operation can be carried out on the different blocks. More specifically, the logical blocks are formed so that physical blocks thereof can have separate channels. As depicted in FIG. 1, when the number of channels is 5, the logical blocks are formed to include a maximum of five physical blocks. The number of channels and physical blocks may also be greater or lesser than five. Further, data is written and read in units of a logical page which is a set of physical pages (set of physical pages for each channel) included in the logical block.

In the case of unreadable data in a block, the correction code for restoring the relevant block data from other block data is written in advance to at least one of the physical blocks in a logical block group. Accordingly, while reading the data, the read target data can be restored using other data in the logical page and the correction code even when a bad block is encountered. Thus, the data can be read “virtually” from the bad block, which may have been written with errors or may have acquired errors after initial writing.

On the other hand, in SSD 100, if the redundant data is read without rewriting, the errors in that data increase. Therefore, a refresh operation is executed by rewriting the data which is otherwise not required to be rewritten along with the data having many errors to a new, separate location. Refresh operations are executed by the refresh control module 22.

The following processes are carried out during refresh:
When a data read is initiated, the data which is already read but has many errors (as compared with the predetermined values for error levels) is considered for refresh. Such data is rewritten in a separate block.
Periodically, data is read by circulating through physical blocks of NAND flash. The block where data is read but has many errors is considered for refresh.

Further, when the data on the bad block is damaged this data is not used and is not subject to refresh.

Here, the read data requiring less frequent rewriting or the data group (referred to as ‘read-only data group’) which are not rewritten exist in the data which is written in NAND flash 10. The below mentioned data is included in the read-only data group:

(1) System data (firmware, system information, and password) managed in SSD system

(2) User data statistically recognizable as having less frequent rewriting requirements

For the user data which can be recognized as having statistically less rewriting, the number of rewrites of user data is counted. From the counted number of rewrites, the user data which is less than or equal to some threshold value is recognized as the user data requiring less frequent rewriting.

Further, as shown in FIG. 4, the two user data storage areas including NAND buffer area 10a and main storage area 10b can be defined in NAND flash 10. The user data which is not invalid in NAND buffer area 10a and is transferred to main storage area 10b can be recognized as user data with less rewriting. The user data written to NAND flash 10 is first written in NAND buffer area 10a. It is transferred to main storage area 10b after first passing through NAND buffer area 10a. NAND buffer area 10a becomes a FIFO (first-in-first-out) structure in the writing order of the data (LRU: Least Recently Used). The FIFO structure is managed by blocks. When the data of a specific LBA already exists in NAND buffer area 10a and new data for the same LBA is entered in NAND buffer area 10a (e.g., the data in the LBA has been changed according to user operations), the existing data from NAND buffer area 10a is invalidated and it is not rewritten or stored in main storage area 10b.

The data of LBA which is the same as the data input in the NAND buffer area 10a is nullified in the block and any block for which all the data in the block becomes invalid is released as a free block. A block which reaches the end of the FIFO management structure of NAND buffer area 10a without being invalidated by user operations is considered as the data with a low possibility of being rewritten and it is moved under the management of main storage area 10b. The data with high update frequency is nullified while passing NAND buffer area 10a. Since only data with low update frequency overflows from the NAND buffer area, data with high update frequency and data with low update frequency can be sorted in the NAND buffer area 10a. Therefore, upon reaching the end of the FIFO management structure, the data in the block which is moved and rewritten in main storage area 10b can also be recognized as the user data having a rewrite frequency less than the fixed value.

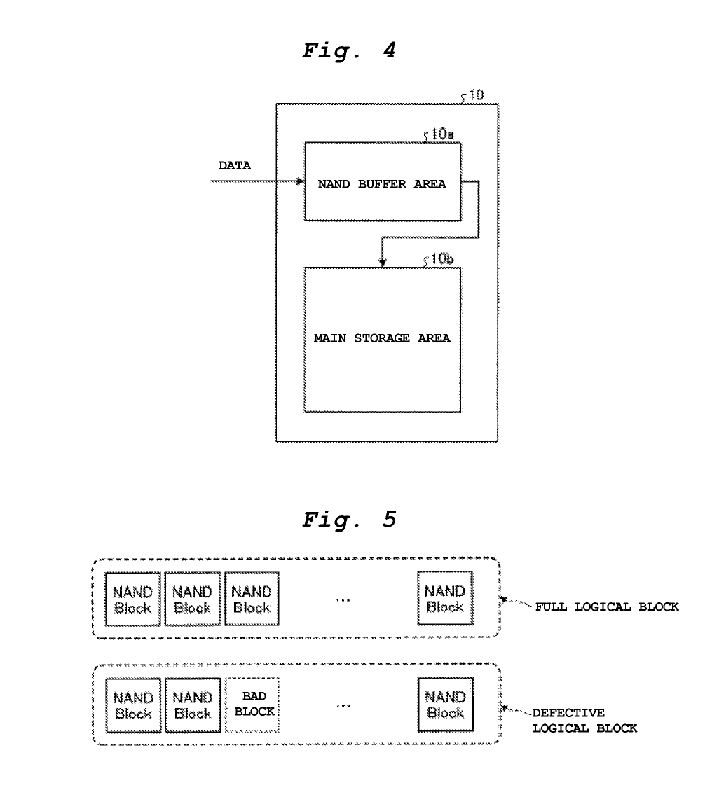

In this embodiment, as shown in the FIG. 5, two types of logical blocks are constructed: a full logical block which is composed of normal physical blocks and a defective logical block composed of normal physical blocks and one “bad” physical block. The building process of such a logical block is carried out according to the logical block building module 21. A “bad” block is a block which generally cannot be used for storage since it has excessive of errors. Alternatively, a dummy physical block (virtual defective block) can be used as the defective block, in which case the physical block is not actually allocated for writing the data.

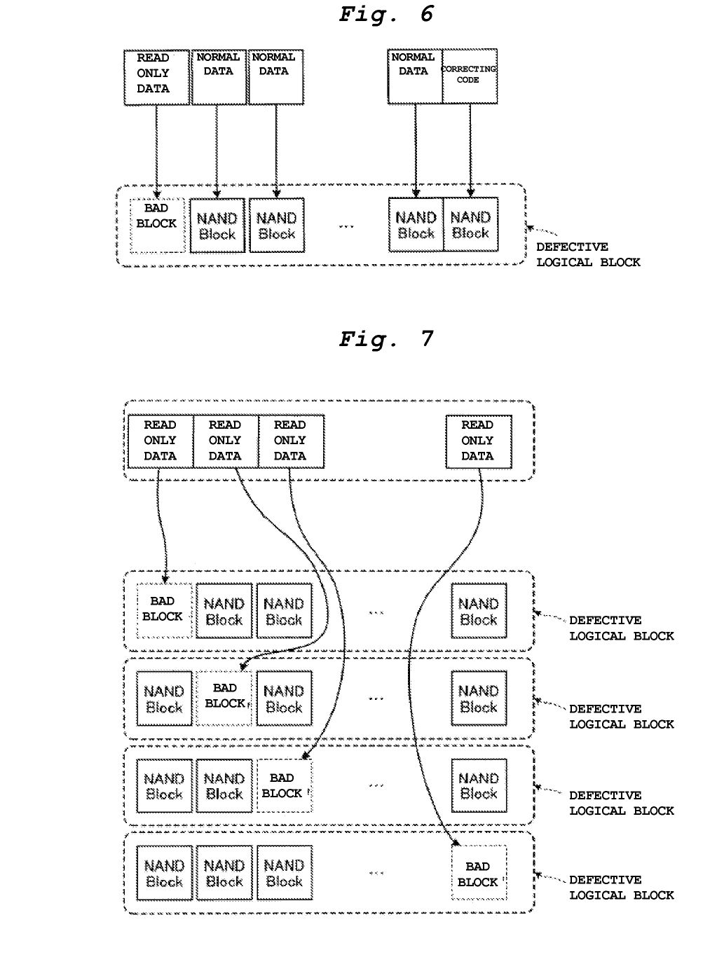

Thus, when data is targeted for a write in the defective logical block, as shown in the FIG. 6, read-only data is targeted for the write in the bad block and data other than the read-only data (“normal data”) and the correction code is written in normal (non-defective) physical blocks. The actual writing operation to the bad block is not carried out, because errors can be generated by actually writing to the bad block or there can be a failure in writing (i.e., the actual writing operation is not successfully completed).

When the read-only data is read, it is generated by carrying out the restoration process using other data in the logical block, including the correction code. Since the bad block is not a refreshing target, the data which is “virtually” written in the bad block position does not become a refresh target. Therefore, as for the bad block, the rewriting frequency due to refreshing of the data is lowered as compared with the condition in which the read-only data is written to a normal physical block.

Furthermore, in the defective logical block, when selecting the multiple physical blocks which are combined with the bad block, it is preferable to select highly reliable physical blocks such as physical blocks with a smaller number of error corrections.

FIG. 7 shows the construction of multiple logical blocks by arranging multiple read-only data in a bad block of multiple defective logical blocks or in the virtual bad block. In other words, the total amount of the read-only data is determined. If it is necessary to arrange all these read-only data in the bad physical block position at the time of constructing the previous logical block, only the total amount of read-only data is provided to the bad physical block (or dummy physical block) and is included in the logical block. As a result, if the positions of the bad physical block are distributed, the number of logical blocks increases as compared with the construction of the logical block using all full logical blocks. Thus, by writing the read-only data in a bad logical block, the frequency of refresh is lowered, and the overall logical block capacity (count) can be increased accordingly.

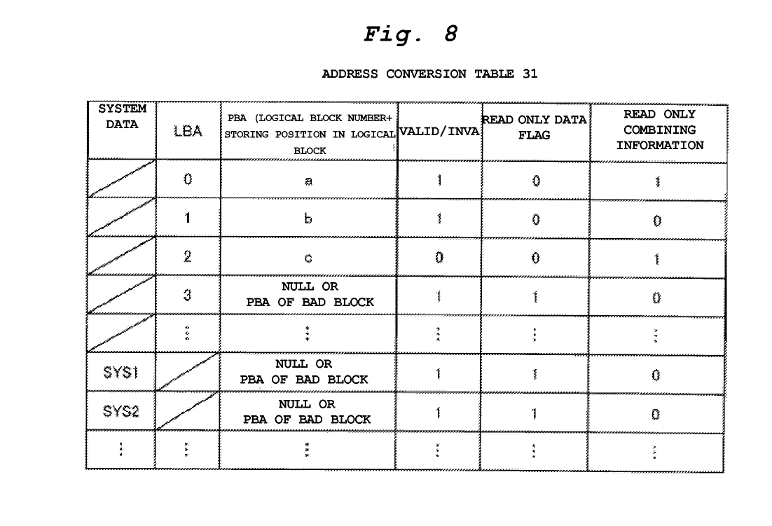

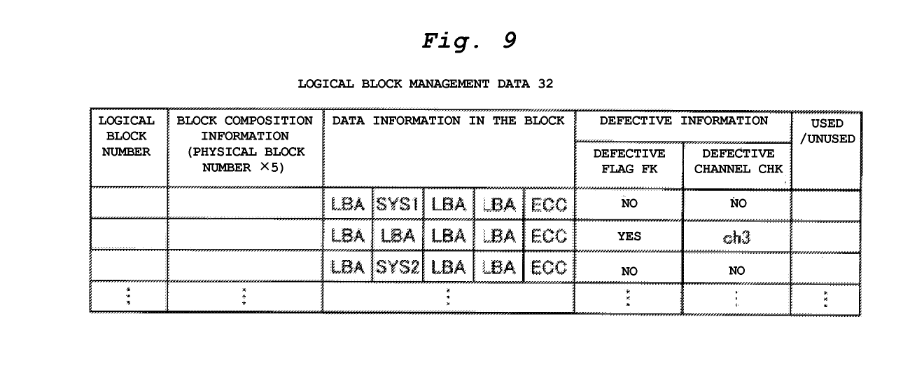

FIG. 8 shows an address conversion table 31 managed by RAM 30. The address conversion table 31 includes system data identification information to identify the type (sys 1, sys 2, . . . ) of read-only system data. PBA (physical block address: for instance, logical block number and the memory position in the logical block which stores the data) is the memory position on the NAND flash 10 which stores LBA as the logic address specified from the host device 1, or the data for the system data identification information of read-only and valid/invalid flag which shows whether this data is valid and data for this LBA, or read-only data flag which shows whether the data for the system data identification information of read only is read only data and read only combination information which shows whether the data corresponding to this LBA constructs the logical block combined with read only data.

For the read only data, PBA of a null or bad block is registered in PBA as shown in LBA “3”, “sys 1”, “sys 2”. In other words, when the read-only data is written in the bad physical block, the PBA of the bad block is registered. When read-only data is registered in a dummy physical block (virtual bad physical block), “null” is registered. The read-only data flag identifies the user data recognized as user data requiring statistically less frequent rewriting and the column of LBA for such user becomes “1”. Also, with the read-only system data, the read-only data flag becomes “1”. As for the read-only combination information, the column of the normal data which is constructed by the logical block combined with the user data for read only or system data for read only, becomes “1”.

FIG. 9 shows the logical block management table 32 stored in the RAM 30. The registration of the data to the logical block management table 32 is primarily executed by the logical block building module 21. Logical block number and block construction information showing the identification information of the multiple physical blocks (5 in this embodiment) which form this logical block and the data information in the block identifying the data arranged in the logical block as well as defect information and used/unused information are registered in the logical block management table 32. The numbers (addresses) of the physical blocks which form the logical block are registered in the block construction information.

The construction information in the block includes the information of the data (LBA, system data identification information sys 1, sys 2, . . . , error correcting code) arranged in the physical blocks of the logical blocks.

Defect information includes defective flag Fk and defective channel chk. Defective flag Fk identifies whether all the physical blocks are the same or not. In other words it identifies whether a bad physical block (or virtual bad physical block) exists. The defective flag Fk identifies whether the logical block is a full logical block or a defective logical block. Defective channel chk shows the channel number where the bad physical block (or virtual bad physical block) is positioned.

Used/unused information identifies whether each logical block is being used or not. In other words, it identifies whether each logical block is a free block or an active block. “Free” meaning no valid data is currently stored in the logical block. “Active” meaning a block is not free. By using this used/unused information it is possible to select the free block which is used at the time of writing NAND flash 10. Furthermore, the free blocks include both blocks in which write is never done and blocks in which write is done once after which all data becomes invalid. A free block may be erased according to a fixed schedule before it is used as an active block.

In SSD 100, the relation between the logical address (LBA) and the physical address (memory position in NAND flash 10) is not statically determined in advance. A logical/physical dynamic conversion method which can be altered at the time of writing is adopted. For instance, when the data of same LBA is to be overwritten, the following process can be carried out. In the logical address A1, valid data of a block size is stored and block B1 is considered used (active). When the command to overwrite and update data of the logical address is received from the host 1, one free block (it is assumed here to be the block B2) is secured and the data received from host 1 is written in this free block. After that, the logical address A1 and the block B2 are connected. As a result, block B2 becomes an active block. Since the data stored in the block B1 is now invalid after the update, block B1 becomes a free block.

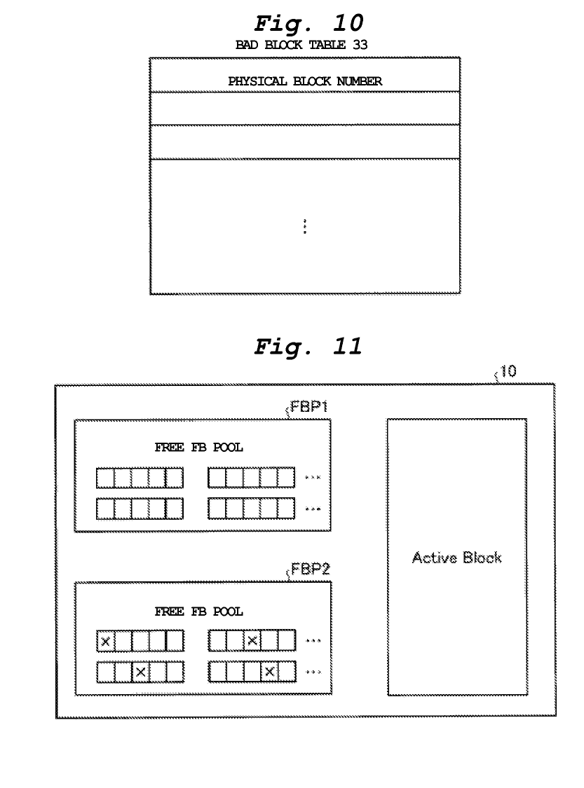

FIG. 10 shows bad block table 33 that is managed by controller 20. “Built-bad” blocks which are bad from initial manufacture and “acquired bad” blocks which become bad during usage are registered in the bad block table 33. For instance, the physical block number which shows the bad block is registered in the bad block table 33. Furthermore, a built-bad block can be managed such that it is not registered in the bad block table 33.

FIG. 11 conceptually shows the blocks in the NAND flash 10. The logical block in the NAND flash 10 includes the active block, which is the logical block where usage is allocated, and the free block, which is the logical block where the usage is unallocated and which does not contain valid data. The free blocks include the full blocks composed only of normal physical blocks and the defective blocks (blocks with at least one bad physical block (or virtual bad physical block)). Full free blocks are pooled in the free block pool FBP1 and the free defective blocks are pooled in the free block pool FBP2.

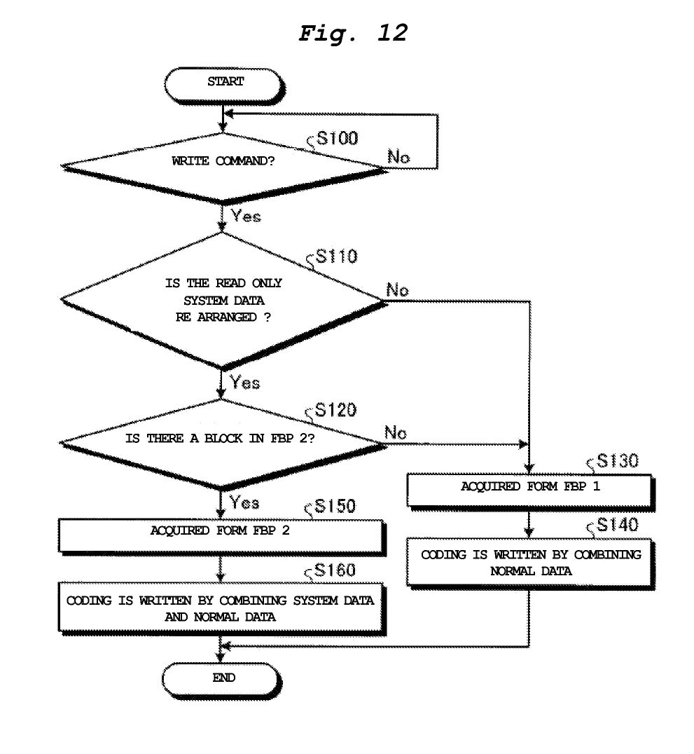

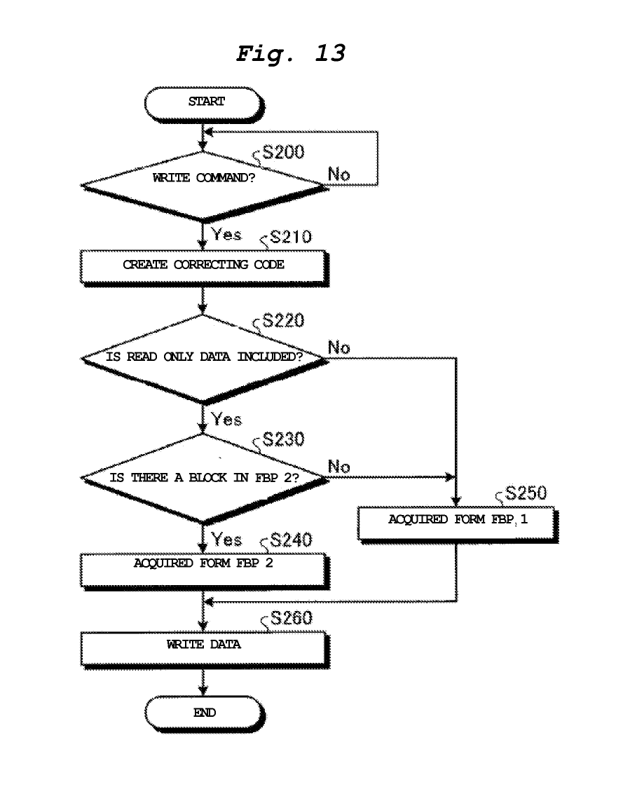

FIG. 12 is a flow chart showing the writing operation in the initial usage stage of SSD 100. The system data set as read-only data is written in a fixed management area of NAND flash 10 for first handling of SSD 100.

When a write instruction is received from host 1 (step S100), the data access control module 23 of the controller 20 temporarily stores the write data received from the host 1 in RAM 30 through host I/F 150 and RAMC 35. After that, as for the data access control module 23, data is read from RAM 30 and input in the ECC control module 50 through RAMC 35.

The data access control module 23 decides the existence of system data for which reallocation with the defective logical block in the system data (read-only data) memorized in the management area (step S110) is to be carried out. When it is determined that such system data exists, the block management module 24 determines whether a free defective block exists in the free block pool FBP2 (step S120). When a free defective block exists in the free block pool FBP2, the free defective block is acquired from the free block pool FBP2 (step S150). The data access controller 23 is notified of the acquired free defective block.

Further, the data access controller 23 reads the system data (read-only data for which repositioning has not been carried out) from the management area of NAND flash 10. It inputs this data to ECC processor 50 through NANDC 40. ECC processor 50 forms the error correction code based on the system data (read-only data) and the normal data input from RAM 30. Moreover, data access controller 23 acquires the information of the acquired free defective block from the logical block management table 32. So that the normal data is positioned properly within the defective logical block, the system data (read-only data) is positioned in the bad block (virtual bad block) of the free defective block, data access controller 23 provides the correspondence relation between the normal data and system data and the channel number for the ECC processor 50. Based on the provided correspondence relation, the ECC processor 50 outputs the normal data and system data to the NANDC 40-0 to 40-3 corresponding to the predetermined channel and the formed error correction coding is output to NANDC 40-4 of ch4. Accordingly, as shown in FIG. 6, the read-only system data is associated with the bad block of a free defective block and normal data and error correction coding are associated with the good blocks of a free defective block (step S160). After writing the normal data and the error correction coding, data access controller 23 updates the address conversion table 31 and logical block management table 32.

In step S110, if it is determined by the data access controller 23 that, in the system data stored in the management area (read-only data), there is only system data which is not to be reallocated (step S110: No), or in step S120, if it is determined that there is no free defective block in the free block pool FBP2 (step S120: No), a free full block is acquired from the free block pool FBP1 (step S130) and the acquired free full block is identified to the data access controller 23. Moreover, ECC processor 50 forms the error correcting code based on normal input data by RAM 30, ECC processor 50 outputs the normal data to NANDC 40-0 to 40-3 corresponding to each predetermined channel Ch0-Ch3, and outputs the formed error correcting code to NANDC 40-4 of ch4. By this, normal data and the error correcting code is written to the good blocks of a free full block (step S140). After writing, data access controller 23 updates the address conversion table 31 and logical block management tables 32.

By repeating this process, the system data (read-only data) written to the specific management area of NAND flash 10 is repositioned (reallocated) to the bad block of a defective logical block.

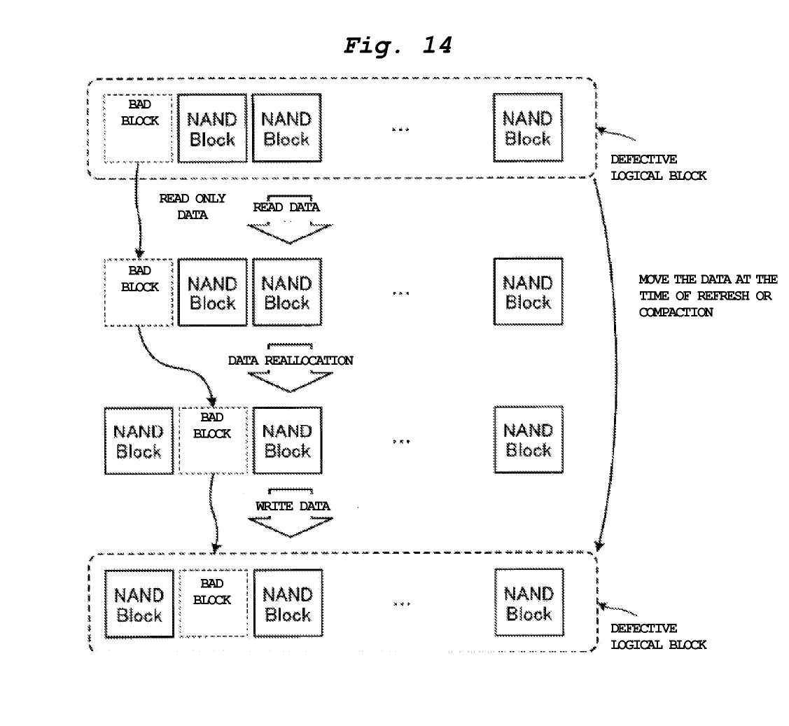

FIG. 13 is a flow chart showing the writing operation after identification and classification of user data requiring statistically less rewriting. In the address conversion table 31, for the LBA for the user data which requires statistically less rewriting, the read-only data flag becomes 1. When the data access controller 23 of controller 20 receives the write command from host 1, the write data received from host 1 is temporarily stored in RAM 30 through host I/F 150 and RAMC 35. After this, data access controller 23 reads the data from RAM 30 and inputs it to ECC processor 50 through RAMC 35. ECC processor 50 forms the error correction code based on the input data. Controller 20 retrieves the read-only data flag of the address conversion table based on the LBA included in the write command and it is determined whether this write data contains read-only data (step S220). If it does not contain read-only data, a free full block is acquired from the free block pool FBP1 (step S250) and write data is written to the acquired free full block (step S260).

On the other hand, if it is determined by controller 20 that this write data contains read only data (step S220: Yes), it is determined whether a defective free block exists in free block pool FBP2 (step S230). If a defective block exists in free block pool FBP2, the free defective block is acquired from the free block pool FBP2 (step S240) and write data is targeted for a write to the acquired free defective block (step S260).

However, in step S230, when determined by controller 20 that a free defective block does not exist in free block pool FBP2, a free full block is acquired from the free block pool FBP1 (step S250) and data is written to the acquired free full block (step S260). After writing, data access controller 23 updates the address conversion table 31 and logical block management table 32.

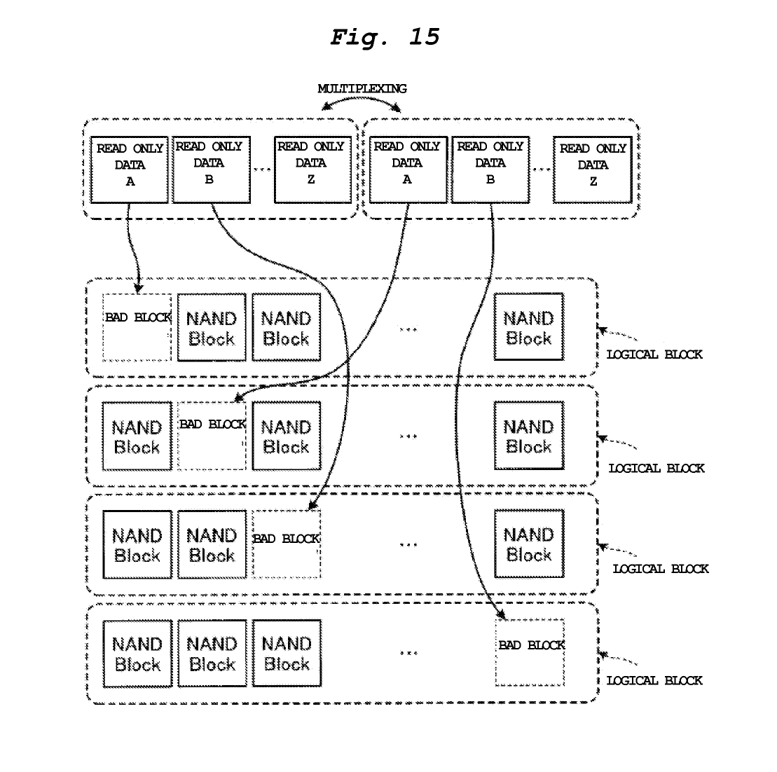

Further, at the time of the above-mentioned refresh process, or compaction process, while carrying out the data transfer between the defective logical blocks, as shown in FIG. 14, the position of the bad block of transfer source and transfer destination is different. Therefore, at this time, repositioning of the data so as to write the data of the bad block position of transfer source to the bad block position of transfer destination is carried out. As a result, the read-only data is always placed in the bad block position, irrespective of the data transfer and the frequency of the rewriting generation due to refreshing can be kept low.

Moreover, when the read-only data is important data like the system data, as shown in the FIG. 15, read-only data is written in each bad block of multiple defective logical blocks until the necessary reliability is obtained and multiplexing can be carried out.

In this way, in this embodiment, two types of logical blocks are constructed including a full logical block which includes only normal physical blocks and a defective logical block including normal physical blocks and one bad physical block (or dummy physical block). Read-only data (data which is generally not rewritten) is selected or alternatively data for which the rewriting frequency is low may be selected and used as read only data. The selected read only data is targeted for a write to the bad physical block (or dummy physical block) of the defective logical block and normal data is written to the normal physical blocks in the defective logical block. Moreover, the coding result of the error correction on the read only data and the normal data is written in a normal physical block included in the defective logical block. Thus, when the data is read from the defective logical block, normal (usual) data and read-only data which uses the coding result may be restored by decoding.

As a result, in this embodiment, longer operating life of the non-volatile semiconductor memory can be accomplished by reducing the frequency of refresh. Moreover, the capacity of the memory device can be increased accordingly.

Furthermore, in the above mentioned embodiments, though only one defective block is included in the defective logical block, if restoration is possible by error correction then logical blocks with more than two defective blocks can be used. Moreover, as for the logical block, the physical blocks can be combined such that not only parallel channel operation but also bank interleaving and plain speed operation can be executed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of controlling a non-volatile semiconductor memory device having a plurality of physical memory blocks, the method comprising:
forming a logical block including a plurality of normal physical blocks and at least one defective physical block;
allocating the defective physical block as a write target for a first data block and the normal physical blocks as write targets for a plurality of second data blocks;
writing the second data blocks and an error correction coding for reproducing the first data block in the plurality of normal physical blocks; and
when the first data block is requested to be read, generating the first data block using the error correction coding.

2. The method of claim 1, wherein the first data block includes system data.

3. The method of claim 1, wherein the first data block includes user data which is infrequently rewritten.

4. The method of claim 1, wherein, when the first data block is requested to be read, generating the first data block using the error correction coding and the second data blocks.

5. The method of claim 1, wherein the logical block includes only a single defective physical block.

6. The method of claim 1, wherein a total number of the normal physical blocks and the defective physical blocks is equal to a total number of channels available for writing data.

7. The method of claim 1, wherein the error correction coding is generated using the first data block and the plurality of second data blocks.

8. A method of controlling a non-volatile semiconductor memory device having a plurality of physical memory blocks, the method comprising:
forming a first plurality of logical blocks including no defective physical blocks;
forming a second plurality of logical blocks including at least one defective physical block;
receiving a write command;
determining whether the write command includes read-only data;
selecting a logical block from the first plurality of logical blocks if it is determined the write command does not include read-only data;
selecting a logical block from the second plurality of logical blocks if it is determined the write command includes read-only data; and
writing data according to the write command to a selected logical block.

9. The method of claim 8, further comprising:
generating an error correction coding for the read-only data and writing the error correction coding to a non-defective physical block of the selected logical block.

10. The method of claim 9, wherein the defective physical block of the selected logical block is allocated to the read-only data.

11. The method of claim 10, wherein the read-only data is not actually written to the defective physical block of the selected logical block.

12. The method of claim 10, wherein the error correction coding is generated using the read-only data and data stored in other non-defective physical blocks of the selected logical block.

13. The method of claim 8, further comprising:
if it is determined the write command includes read-only data, determining whether there is an unused logical block in the second plurality of logical blocks before selecting a logical block.

14. The method of claim 8, further comprising:
if there is no unused logical block in the second plurality of logical blocks, selecting a logical block from the first plurality of logical blocks.

15. A memory system, comprising:
a nonvolatile semiconductor memory including a plurality of physical memory blocks;
a memory controller configured to form a defective logical block including a plurality of normal physical blocks and at least one defective physical block; and
an error correction processing module configured to generate an error correction coding;
wherein the memory controller allocates the defective physical block to a first data block including read-only data and the normal physical blocks to second data blocks and an error correction coding for reproducing the first data block.

16. The memory system of claim 15, wherein the error correction processing module generates the error correction coding for reproducing the first data block using the first data block and the second data blocks.

17. The memory system of claim 16, wherein the read-only data is not actually stored in the defective physical block.

18. The memory system of claim 15, wherein the memory controller includes:
a logical block building module configured to form logical blocks using the plurality of physical memory blocks;
a refresh control module configured to control a refresh process on the nonvolatile semiconductor memory;
a data access control module configured to control reading from and writing to the nonvolatile semiconductor memory according to instructions from a host controller; and
a block management module configured to track a usage state of the logical block, the usage state indicating whether the logical block is being used to store valid data.

19. The memory system of claim 15, further comprising:
a transfer cache configured to store data to be stored in the nonvolatile semiconductor memory; and
a transfer cache controller configured to control the transfer of data from a host system to the transfer cache and the transfer of data from the transfer cache to the nonvolatile semiconductor memory.

20. The memory system of claim 15, wherein a total number of normal memory blocks and defective physical blocks is equal to a number of data channels available for transferring data to the nonvolatile semiconductor memory.
